(19) United States
(12) Patent Application Publication
(10) Pub. No.: US 2010/0051555 A1
(43) Pub. Date: Mar. 4, 2010

(54) Process of removal of arsenic from water

(76) Inventor: Frank S. Craft, SR., Memphis, TN (US)

Correspondence Address: WRIGHT, LINDSEY & JENNINGS LLP, 200 WEST CAPITOL AVENUE, SUITE 2300, LITTLE ROCK, AR, 72201-3699, US

(21) Appl. No.: 12/583,850

(22) Filed: Aug. 27, 2009

Related U.S. Application Data
(60) Provisional application No. 61/190,288, filed on Aug. 27, 2008.

(51) Int. Cl. C02F 1/52; C02F 1/42

(52) U.S. Cl. 210/665; 210/721; 210/722; 210/688

(57) ABSTRACT

An arsenic removal process where arsenic 3 is oxidized to arsenic 5 where the water is passed upflow through a bed of manganese dioxide (MnO₂) at a sufficient flow rate such that the MnO₂ bed is fluidized whereby precipitating or precipitated iron and/or manganese and/or any other suspended solids will pass through the bed. The suspended matter is then removed by passing the water through disposable or reusable filters. The oxidized arsenic is then removed by passing the water through applicable arsenic removal media.

### CROSS-REFERENCE TO RELATED APPLICATIONS

This application claims the benefit of U.S. Provisional Patent Application No. 61/190,288 filed Aug. 27, 2008, the disclosure of which is incorporated herein by reference in its entirety.

### STATEMENT REGARDING FEDERALLY SPONSORED RESEARCH OR DEVELOPMENT

Not applicable.

### BACKGROUND OF THE INVENTION

1. Field of the Invention

The present invention relates to oxidative processes for the removal of arsenic from water and in particular to such processes that use beds of manganese dioxide.

2. Brief Description of the Related Art

Various media are used to remove arsenic from drinking water and waste water, including iron-based and titanium-based adsorption media. There are typically two variations or species of arsenic in water-arsenic 3 (As3) and arsenic 5 (As5). This is significant because As3 is very difficult to remove from water and must be changed or oxidized to As5 before it can be removed. The oxidant used for the conversion of As3 to As5 will also oxidize iron (Fe) and/or manganese (Mn), which is usually present in ground water. The Fe and/or Mn will precipitate after oxidation, necessitating a filter to remove the now suspended material.

A well known method of oxidation of As3 to As5 is oxidant addition (the oxidant may include, but not is not limited to, air, oxygen, NaOCl, H₂O₂, ozone or ozone plus ultraviolet light) followed by a bed of manganese dioxide (MnO₂) (available under various trade names including FILOX and CATALOX). The MnO₂ is also a good filter media for removal of the precipitated suspended material. When the MnO₂ bed becomes loaded with the precipitated suspended Fe and/or Mn, it can simply be backwashed to remove the trapped suspended material.

Some municipal well sites have no sewer drain or means of backwash water disposal. In this case, a backwash tank can be utilized to (1) receive and store the backwash water, (2) act as a sludge separator/water clarifier such that the precipitated sludge can be periodically removed from the bottom of the backwash tank via suction truck or pump to a filter press, and the clarified water can be pumped from the top or center of the tank back to the front end of the oxidation/filtration bed.

The backwash tank method of managing the oxidation/precipitation solids adds cost and space requirements that are not practical for relatively small systems, so the method described above may not applicable for lower flow systems (<about 200 gpm).

The limitations of the prior art are overcome by the present invention as described below.

### BRIEF SUMMARY OF THE INVENTION

The present invention is directed to a process that satisfies the need for an arsenic removal process that is applicable to relatively small water systems. In the process of the present invention, the water is passed through the bed of MnO₂ at a sufficient flow rate to fluidize the bed. The precipitating or precipitated Fe and/or Mn and/or any other suspended matter in the bed is passed through the bed where it is removed by reusable or disposable filters. Therefore, the process does not require periodic backwash or a backwash water holding tank.

Benefits of this process include:

Conversion of As3 to As5 with no backwash water, and

Partial removal of arsenic by coagulation with the Fe present in the water and the Fe trapped on the filter, thereby taking capacity load off of the downstream arsenic removal system.

It is therefore an object of the present invention to provide for an arsenic removal process that is beneficial to small water systems.

It is a further object of the present invention to provide for an arsenic removal process that avoids the need for periodic backwash or for backwash water holding tanks.

It is also an object of the present invention to provide for an arsenic removal system that is more efficient in removing arsenic from water.

These and other features, objects and advantages of the present invention will become better understood from a consideration of the following detailed description of the preferred embodiments.

### DETAILED DESCRIPTION OF THE INVENTION

The present invention is an improvement on a process for the removal of arsenic from water containing arsenic 3 (As3), arsenic 5 (As5), iron (Fe), manganese (Mn) and suspended solids, wherein the As3 is oxidized to As5 in a bed of manganese dioxide (MnO₂). In the present invention, the water is passed upflow through the bed of MnO₂ at a sufficient flow rate to fluidize the bed. The precipitating or precipitated Fe and/or Mn and/or any other suspended matter in the bed is passed through the bed where it is removed by reusable or disposable filters. Therefore, the process does not require periodic backwash or a backwash water holding tank.

The improvement of the present invention comprises the steps of:

(1) Passing the water upflow through the bed of MnO₂ at a sufficient flow rate to fluidize the bed of MnO₂ bed whereby precipitating or precipitated Fe and/or Mn and/or any other suspended solids will pass through the bed,

(2) Passing the water through disposable or reusable filters to remove the suspended solids, and

(3) Passing the water through an arsenic removal media.

An oxidant may be injected into the water prior to step (1), in which case air elimination by means of an air elimination valve may be required following step (1).

The oxidant injection may not be necessary, at least for a period of time, as the MnO₂ may serve as both the oxidant and catalyst. If so, the air elimination step is not required.

The present invention has been described with reference to certain preferred and alternative embodiments that are intended to be exemplary only and not limiting to the full scope of the present invention as set forth in the appended claims.

What is claimed is:

1. In a process for the removal of arsenic from water containing arsenic 3 (As3), arsenic 5 (As5), iron (Fe), manganese (Mn) and suspended solids, wherein the As3 is oxidized to As5 in a bed of manganese dioxide (MnO₂), the improvement comprising the steps of:
(a) passing the water upflow through the bed of MnO₂ at a sufficient flow rate to fluidize the bed of MnO₂ bed whereby precipitating or precipitated Fe and/or Mn and/or any other suspended solids will pass through the bed,
(b) passing the water through disposable or reusable filters, and
(c) passing the water through an arsenic removal media.

2. The process of claim 1, wherein said flow rate of step (b) is in the range of 15-25 gpm/ft².
